(19) United States
(12) Patent Application Publication
(10) Pub. No.: US 2023/0396833 A1
(43) Pub. Date: Dec. 7, 2023

(54) REMOVING DISFLUENCIES FROM AN AUDIO STREAM

(71) Applicant: Claps Artificial Intelligence Inc., New York, NY (US)

(72) Inventors: Jacob Lewis, New York, NY (US); Jose Manuel Gonzalez de Rueda, Madrid (ES)

(21) Appl. No.: 17/833,459

(22) Filed: Jun. 6, 2022

(51) Int. Cl. H04N 21/439; G06F 3/16

(52) U.S. Cl. CPC H04N 21/4394; G06F 3/165; H04N 21/4396

(57) ABSTRACT

Removing disfluencies from an audio stream is disclosed, including: receiving an audio stream comprising payload segments and disfluency segments; determining windows of audio in the audio stream; identifying the disfluency segments in the audio stream using the windows of audio; and modifying the audio stream by removing at least a portion of the disfluency segments.

### BACKGROUND OF THE INVENTION

An individual's disfluent speech (e., a disruption in the flow of spoken language) may be distracting for an audience member. In order to target the locations of an individual's disfluent speech in a recording of the speech, the speech can first be transcribed into text and then the disfluent events can be found within the text. The disfluent events that are located within the text transcription can then be edited from the recorded audio of the speech. However, conventional text transcription techniques may already filter out the presence of disfluent speech events and/or do not properly capture the exact locations at which disfluent events exist within a recording. As a result, it would be desirable to efficiently edit a recording of audio in a way that accurately removes the presence of disfluent events.

### BRIEF DESCRIPTION OF THE DRAWINGS

Various embodiments of the invention are disclosed in the following detailed description and the accompanying drawings.

FIG. 1 is a diagram showing an embodiment of a system for removing disfluencies from an audio stream.

FIG. 2 is a diagram showing an example of a device configured to perform programmatic audio and/or video stream editing in accordance with some embodiments.

FIG. 3 is a flow diagram showing an embodiment of a process for removing disfluencies from an audio stream.

FIG. 4 is a flow diagram showing an example of a process for real-time identification of disfluency segments in windows of audio of an audio stream in accordance with some embodiments.

FIG. 5 is a diagram showing two adjacent windows of audio that have been applied to an audio stream that is still being recorded.

FIG. 6 is a flow diagram showing an example of a process for confirming identification of disfluency segments in windows of audio against text transcription in accordance with some embodiments.

FIG. 7 is a flow diagram showing an example of a process for determining candidate removal segments based on identified disfluency segments in accordance with some embodiments.

FIG. 8 is a flow diagram showing an example of a process for selectively removing candidate removal segments from an audio stream and a time-aligned video stream in accordance with some embodiments.

FIG. 9 is a diagram showing an example of selectively removing candidate removal segments from an audio stream and a time-aligned video stream.

FIG. 10 is a flow diagram showing a process for verifying the quality of the editing of an audio stream in accordance with some embodiments.

FIG. 11 is a flow diagram showing a process for determining a payload fluent runtime associated with an edited audio stream in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of removing disfluencies from an audio stream are described herein. An audio stream comprising payload segments and disfluency segments existing in an audio space is received. In some embodiments, the recording of the audio stream is still in progress. In some embodiments, the recording of the audio stream has completed. For example, the audio stream may comprise an audio recording of a user's speech or is included in a video recording of a user's speech. In various embodiments, a “disfluency” event comprises a portion of the audio recording that is associated with a disfluency event in the user's speech. Examples of a disfluency event include pauses, filler words (e.g., “uh” or “um”), stutters, an interjected sound or word, reparandums (e.g., correction of previously uttered speech), repetitions (e.g., of a syllable of a word), prolonged sounds, blocks or stops, and substitutions. In various embodiments, a “payload” event comprises a portion of the audio recording that is not associated with a disfluency event in the user's speech. In various embodiments, a “segment” of a stream (e.g., recording) refers to the duration of the stream between a start timestamp and an end timestamp of a corresponding event (e.g., a payload or disfluency event). Windows of audio in the audio stream are determined. In some embodiments, a sliding window of a predetermined length of time (e.g., five seconds) is (e.g., at regular intervals) shifted towards the most recently recorded portion of the audio stream as it is being recorded to check for the presence of any disfluency segments within that sliding window. The audio content that is included within adjacent windows may overlap, depending on the interval at which the sliding window shifts towards the most recently recorded audio content. The audio stream is then modified to remove at least a portion of the identified disfluency segments. Because the identified disfluency segments that include disfluency events may distract from the flow and the value of the remaining payload segments of the audio stream, the audio stream may be edited/modified to remove at least some of the disfluency segments (e.g., portions of the audio recording that include disfluencies) to result in a shorter audio stream with speech that flows smoother/more fluently than the original audio stream.

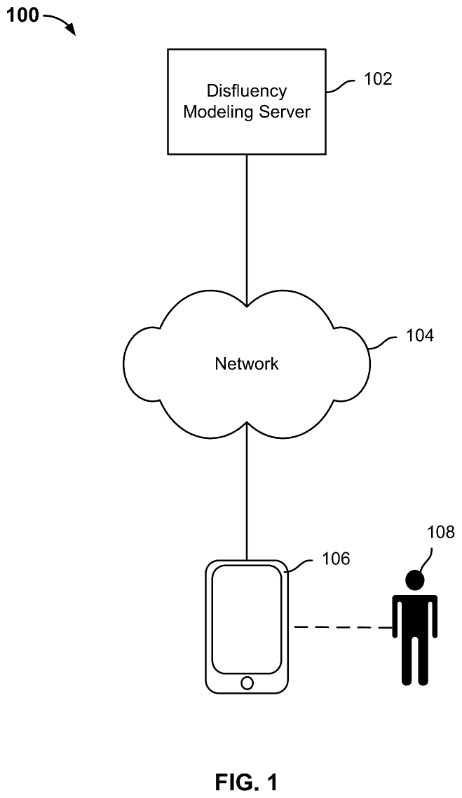

FIG. 1 is a diagram showing an embodiment of a system for removing disfluencies from an audio stream. As shown in FIG. 1, system 100 includes disfluency modeling server 102, network 104, and device 106. Network 104 includes data and/or telecommunications networks. Disfluency modeling server 102 and device 106 communicate to each other over network 104.

Device 106 is a device that includes a microphone that is configured to record audio, such as speech, that is provided by user 108. In some embodiments, device 106 also includes a camera or other sensor that is configured to record a video of user 108. Examples of device 106 include a smart phone, a tablet device, a laptop computer, a desktop computer, or any networked device. In various embodiments, user 108 selects a software application (not shown) for programmatic audio and/or video stream editing to execute at device 106. The software application is configured to provide a user interface that allows user 108 to either upload a previously recorded audio stream and/or a video stream of user 108 or begin recording a new audio stream and/or video stream. For example, during the audio stream and/or video stream, user 108 can be speaking about a topic, sharing a document, and/or holding up visual aids. In the event that a video stream is obtained, the video stream is time-aligned with the audio stream because they were recorded simultaneously. Once a (e.g., completely or partially) recorded audio stream and/or video stream are obtained by the application for programmatic audio and/or video stream editing executing at device 106, the application is configured to apply overlapping, sliding windows across the (e.g., thus far) recorded audio stream to detect for the presence of disfluency events within the recorded speech. As mentioned above, example types of a disfluency event include pauses, filler words (e.g., “uh” or “um”), stutters, an interjected sound or word, reparandums (e.g., correction of previously uttered speech), repetitions (e.g., of a syllable of a word), prolonged sounds, blocks or stops, and substitutions. For example, each sliding window that is applied to a portion of the recorded audio stream can be of a predetermined length of time (e.g., five seconds) and machine learning is applied to this window of speech to detect the presence of one or more instances and types of disfluency events. Each disfluency event that is detected by the application executing at device 106 is identified by a corresponding “disfluency segment,” which includes at least the start timestamp and the end timestamp of when the disfluency event respectively starts and ends within the audio stream. The portions of the audio stream that are not identified by the application as being “disfluency segments” are assumed to be associated with fluent speech (speech that does not include disfluencies) and are referred to as “payload segments.” Each “payload segment” includes at least the start timestamp and the end timestamp of when a portion of fluent speech respectively starts and ends within the audio stream.

In various embodiments, machine learning models (e.g., neural networks) that are configured to detect one or more types of disfluency events may be obtained at device 106 from disfluency modeling server 102. For example, machine learning models are trained at disfluency modeling server 102 to recognize one or more types of disfluency events in audio. For instance, these machine learning models may be trained at disfluency modeling server 102 using training data comprising audio samples that are annotated with the types of disfluency events that are present in each audio sample. In some embodiments, prior to sending a machine learning model to device 106, disfluency modeling server 102 is configured to simplify the machine learning model to optimize that model for running at device 106, which has comparatively fewer computing resources than disfluency modeling server 102. Example techniques of simplifying a machine learning model to optimize the model for running at device 106 include converting certain complex operations that need to be performed by the model to substantially equivalent but simpler operations that can be computed smoothly at device 106 given device 106's computing resources.

In various embodiments, the software application (not shown) for programmatic audio and/or video stream editing executing at device 106 is configured to determine candidate removal segments based on the disfluency segments that have been identified from the recorded audio stream. In various embodiments, a “candidate removal segment” comprises a duration of the recorded stream between a start timestamp and an end timestamp and that is a candidate for removal from the recorded audio stream and/or (the time-aligned) video stream, if available. In some embodiments, the application executing at device 106 is configured to determine candidate removal segments by determining whether to combine a disfluency segment that has been identified from the recorded audio stream with another disfluency segment and/or a payload segment and then consider the combination as a candidate removal segment. For example, a disfluency segment can be combined with a temporally neighboring disfluency segment and/or with a temporally neighboring payload segment into a candidate removal segment if the removal of the combined segments would yield a fluent gap or meet some other criteria for combining. In some embodiments, the application executing at device 106 is configured to determine a single disfluency segment as a candidate removal segment if the disfluency segment is not to be combined with at least one other temporal neighbor segment.

In some embodiments, the software application (not shown) for programmatic audio and/or video stream editing executing at device 106 is configured to remove all candidate removal segments from both the recorded audio stream and the recorded video stream to result in an edited/modified audio stream and a corresponding time-aligned, edited/modified video stream. In some embodiments, the software application (not shown) for programmatic audio and/or video stream editing executing at device 106 is configured to select at least a portion of the candidate removal segments to remove from the recorded video stream based at least in part on content that corresponds to those candidate removal segments. For example, whether a candidate removal segment should be removed from the recorded video stream is determined by checking whether the video frames of the recorded video stream between the start and end timestamps of the candidate removal segment indicate user intentionality to preserve that content (e.g., the user is showing a visual aid in those video frames). In the event that a candidate removal segment is determined to be preserved in the recorded video stream, then, in some embodiments, the application is configured to determine whether to remove that candidate removal segment from the recorded audio segment. For example, even if content in the recorded video stream corresponding to a candidate removal segment is preserved, the candidate removal segment can still be removed from the recorded audio stream (and replaced with silence). Otherwise, in the event that a candidate removal segment is determined to be removed from the recorded video stream, then that candidate removal segment is also removed from the recorded audio stream. The resulting edited/modified audio stream and the edited/modified video stream, if available, are time-aligned and of the same length because either candidate removal segments were removed from both streams or a candidate removal segment was removed from only the video stream but was replaced with silence for the same duration of the segment in the audio stream.

In some embodiments, the software application (not shown) for programmatic audio and/or video stream editing executing at device 106 is configured to determine a payload fluent runtime (which is sometimes referred to as a “fluent runtime” or an “edited runtime”) associated with the edited audio stream and the edited video stream, if available. As mentioned above, the edited audio stream and the edited video stream are of the same length. For example, the runtime of the edited audio stream (and the edited video stream) is determined as the original runtime of the recorded audio stream less the cumulative time associated with the candidate removal segments that were removed from the recorded audio stream. In some embodiments, the application presents the payload fluent runtime associated with the edited audio stream along with the runtime of the original, unedited recorded audio stream so that user 108 can be informed of how much of the original recorded audio stream was removed (e.g., due to the presence of disfluency events) in the recorded speech. Furthermore, the application can also compare the payload fluent runtime against a selection of a desired length of a recorded audio/video stream by user 106 to determine whether the edited audio stream exceeds, meets, or is shorter than that desired length. In some embodiments, the application executing at device 108 is configured to present/play the edited audio stream with the edited video stream. In some embodiments, the application executing at device 106 is configured to present a selected media (e.g., song that is selected by user 108) that overlays the presentation/playback of the edited audio stream with the edited video stream. Because the selected media was not edited with the recorded audio stream and the recorded video stream, if any, the media will play for the duration of the edited audio stream and the edited video stream without interruption.

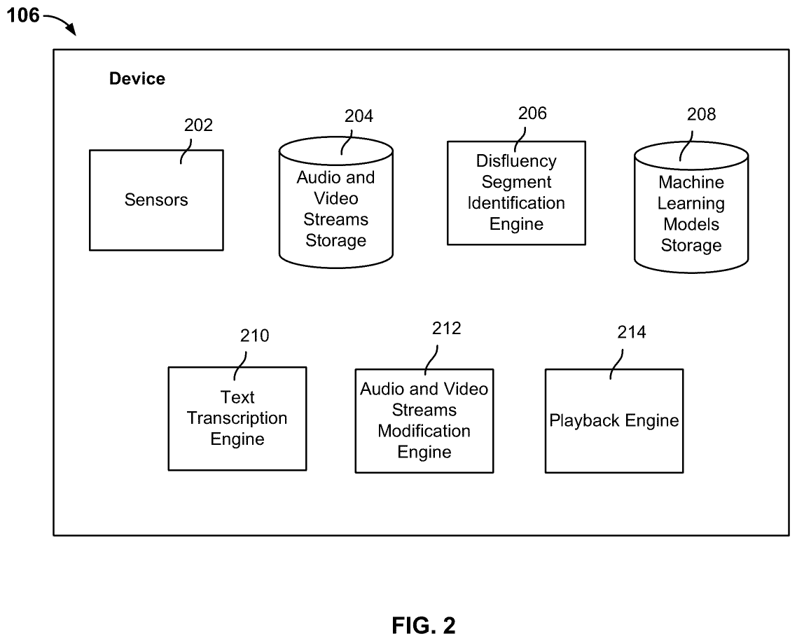

FIG. 2 is a diagram showing an example of a device configured to perform programmatic audio and/or video stream editing in accordance with some embodiments. In some embodiments, device 106 of system 100 of FIG. 1 may be implemented using the example device of FIG. 2. In the example of FIG. 2, the device includes sensors 202, audio and video streams storage 204, disfluency segment identification engine 206, machine learning models storage 208, text transcription engine 210, audio and video streams modification engine 212, and playback engine 214. Each of audio and video streams storage 204 and machine learning models storage 208 may be implemented using any appropriate storage medium. Each of sensors 202, disfluency segment identification engine 206, text transcription engine 210, audio and video streams modification engine 212, and playback engine 214 may be implemented using hardware and/or software.

Sensors 202 include one or more sensors that are configured to capture and record audio stream and video streams. For example, sensors 202 include a microphone for capturing and recording sound/audio streams and a camera for capturing and recording images/video streams. In some embodiments, sensors 202 are activated (e.g., by an operating system and/or an application) to record only an audio stream. In some embodiments, sensors 202 are activated (e.g., by an operating system and/or an application) to record an audio stream and a video stream simultaneously to result in a time-aligned pair of an audio stream and a video stream. The recorded audio streams and video streams are stored at audio and video streams storage 204.

Disfluency segment identification engine 206 is configured to identify disfluency segments associated with disfluency events within recorded audio streams (e.g., that are stored at audio and video streams storage 204). In some embodiments, disfluency segment identification engine 206 is configured to identify disfluency segments within a recorded audio stream in real-time as the audio stream is still being recorded. In some embodiments, disfluency segment identification engine 206 is configured to identify disfluency segments within the audio stream that were previously recorded and then uploaded. When disfluency segment identification engine 206 is configured to identify disfluency segments within a recorded audio stream in real-time, disfluency segment identification engine 206 is configured to, periodically, determine a snippet of the most recently recorded audio and then apply machine learning to the audio in that snippet to identify zero or more disfluency segments within that snippet. In some embodiments, the snippet of the most recently recorded audio is determined to be included in a window of a predetermined length (e.g., five seconds). For example, disfluency segment identification engine 206 is configured to determine a window-length of the most recently recorded audio stream at every predetermined interval (e.g., two seconds) and/or in response to a trigger event (e.g., the end of the audio recording). As a result, as more of the audio stream is recorded in real time, disfluency segment identification engine 206 is configured to continuously shift the window towards newly recorded audio and to apply machine learning to the audio snippet contained in each window to detect for the presence of disfluency segments within the audio snippet. Disfluency segment identification engine 206 is configured to apply machine learning models (e.g., that are stored at machine learning models storage 208), which have been optimized for running on the hardware resources of a device, on window length audio snippets to determine whether disfluency event(s), if any, are present in an audio snippet given the context of the audio within that snippet. If the length of the window is longer than the predetermined interval at which snippets of recently recorded audio are analyzed for disfluency events, then sequentially determined windows may overlap in time and therefore, include overlapping audio content. Overlapping windows of audio may provide different contexts of the same user utterances for which the machine learning models can detect the presence (or lack thereof) of different types of disfluency events. In some embodiments, the portions of the audio stream that are not “disfluency segments” (e.g., the portions of the audio stream comprising the portion from the beginning of the audio stream to the start of the first disfluency segment, between two adjacent/consecutive disfluency segments, and/or from the end of the last disfluency segment to the end of the audio stream) form the “payload segments” of the audio stream.

Text transcription engine 210 is configured to transcribe a recorded audio stream into text. The text transcription includes approximate timestamps of when each word of the audio stream was uttered during the stream. In some embodiments, text transcription engine 210 is configured to transcribe an original, unedited version of a recorded audio stream and also an edited version of the recorded audio stream. As will be described further below, even though, in various embodiments, disfluency segments are determined from an audio stream by directly analyzing the audio, the text transcription of the audio can be used to, for example, confirm whether a disfluency segment should be removed or not from the audio stream and to determine whether the edited version of the audio stream retains enough coherence of the original, unedited audio stream.

Audio and video streams modification engine 212 is configured to determine candidate removal segments based on the disfluency segments that have been identified (e.g., by disfluency segment identification engine 206) from a recorded audio stream. In some embodiments, audio and video streams modification engine 212 is configured to determine that each single disfluency segment is a candidate removal segment. In some other embodiments, audio and video streams modification engine 212 is configured to determine whether a single disfluency segment should form a candidate removal segment or whether a disfluency segment should be combined with a temporally neighboring payload segment and/or disfluency segment, based on a set of tunable combination criteria, to form a candidate removal segment. For example, the set of tunable combination criteria can dictate that a disfluency segment should be combined with a payload segment and another disfluency segment that immediately follows that disfluency segment in the audio stream if the removal of the combination of segments would result in a fluent gap (e.g., based on analyzing the corresponding portion of the text transcription) in the audio stream. As a result of processing the disfluency segments identified from the recorded audio stream, each identified disfluency segment is either determined individually to form a candidate removal segment, or is combined with at least one other disfluency event (and/or optionally, a payload segment) and then the combination is determined to form a candidate removal segment.

Audio and video streams modification engine 212 is configured to determine which candidate removal segments determined from a recorded audio stream are to be removed from the recorded audio stream. Also, where a time-aligned recorded video stream corresponding to the recorded audio stream is available, audio and video streams modification engine 212 is also configured to determine the video frames corresponding to which candidate removal segments to remove from the recorded video stream. In some embodiments, audio and video streams modification engine 212 is configured to remove all candidate removal segments from the recorded audio stream and, where a time-aligned recorded video stream is available, remove the video frames (e.g., between the start and end timestamps) corresponding to all the candidate removal segments from the recorded video stream. In some other embodiments, where a time-aligned recorded video stream is available, audio and video streams modification engine 212 is configured to first check the video frames of the video stream corresponding to each candidate removal segment before determining whether to remove the candidate removal segment from the video stream. For example, if the content within the video frames of the video stream corresponding to the time duration defined by a candidate removal segment matches a set of video preservation criteria (e.g., the content indicates user intentionality), then those video frames are determined to be preserved/kept (e.g., not removed from the video stream). Where video frames corresponding to a time duration as defined by a candidate removal segment are preserved/kept (e.g., not removed from the video stream), audio and video streams modification engine 212 is configured to determine whether to also preserve the audio segment corresponding to the candidate removal segment or to remove that audio segment and replace it with silence in the audio stream, as will be described in further detail below. In the event that video frames of a video stream corresponding to the time duration defined by a candidate removal segment does not match a set of video preservation criteria, then those video frames are determined to be removed from the video stream and therefore, the audio segment of the candidate removal segment is also removed from the audio stream. Audio and video streams modification engine 212 is configured to store the edited audio stream and, if available, the edited video stream at audio and video streams storage 204 and/or upload the edited streams to a server. Because segments of audio and/or video have been removed from the original audio stream and video streams, these edited streams are shorter and take up less storage space than their original counterparts. As such, by storing the edited audio and video streams as opposed to their original, unedited counterparts, significant storage space (whether at the device and/or the server) can be freed up.

After editing a recorded audio stream and if available, a time-aligned video stream, in some embodiments, audio and video streams modification engine 212 is configured to check the coherence of the edited recorded audio stream against the coherence of the original, unedited recorded audio stream. For example, the coherence of the original, unedited recorded audio stream can be determined based on the text transcription of the original, unedited recorded audio stream and the coherence of the edited recorded audio stream can be determined based on a text transcription of the edited audio stream. In some embodiments, a ratio of the coherence of the edited recorded audio stream to the coherence of the original, unedited recorded audio stream can be determined and also compared to a threshold ratio. For example, if the determined ratio is less than the threshold ratio, then it can be determined that the editing of the audio stream can be improved and therefore, performed again based on adjusted parameters of the machine learning models that were used to identify the disfluency segments in the audio stream. Otherwise, if the determined ratio meets or exceeds the threshold ratio, then it can be determined that the editing of the audio stream is valid and that the edited audio stream (and edited video stream) should be played back.

Playback engine 214 is configured to determine a runtime associated with the edited audio stream and if available, a corresponding edited video stream. As mentioned above, this runtime can sometimes be referred to as the “edited runtime,” “fluent runtime,” or the “payload fluent runtime.” Where there was no video stream and only an audio stream, the payload fluent runtime is equivalent to the length of the edited audio stream. Where there were an audio stream and a time-aligned video stream, in the event that the edited audio stream and the edited video stream were already time-aligned (the edited streams are of equal length), then, the payload fluent runtime is equivalent to the length of the edited audio stream or the length of the edited video stream. Where there were an audio stream and a time-aligned video stream, in the event that the payload fluent audio stream and the edited video stream are of unequal length (e.g., because a segment was removed out of the audio stream but not out of the video stream), then the payload fluent runtime is equivalent to the longer of the edited audio stream and the edited video stream. Given that the original audio stream and video stream were edited by removing segments from the streams to generate the edited audio stream and edited video stream, the determined payload fluent runtime is likely shorter than the original runtime of the original audio stream/video stream.

Playback engine 214 is configured to present the determined edited runtime of the edited audio stream and if available, the edited video stream. In some embodiments, playback engine 214 is also configured to present the original runtime of the unedited audio stream along with the payload fluent runtime so that the user can be informed how much of the stream was edited to remove disfluencies. Playback engine 214 is also configured to present/playback the edited audio stream along with the edited video stream, if available. In some embodiments, playback engine 214 is also configured to play a selected song or other media as an overlay to the presentation/playback of the edited audio stream along with the edited video stream. The result is a presentation of an audio (and video, if available) of the user's speech in which disfluencies have been seamlessly removed and with, optionally, the presentation of a selected song or other media that has not been edited based on the disfluency removal.

As shown in FIG. 2, an audio stream of a user's speech that is being recorded at a device can be operated on in real-time to identify disfluency segments. The identified disfluency segments are ultimately used to determine portions of the audio stream to remove. Where a video stream that is time-aligned to the audio stream is available, the video frames of that video stream can be used to selectively determine the audio portions associated with disfluency segments to remove from the audio stream. Also, where a video stream that is time-aligned to the audio stream is available, video frames of the video stream may also be determined to be removed based on the identified disfluency segments. This programmatic editing results in an efficient processing of audio and/or video streams locally at a device to smooth out the perceived, recorded speech/narration of a user. Moreover, the shorter, edited versions of the audio stream and video stream, if any, can be preserved in place of the longer, unedited versions, which can optimize the storage space of the device (and/or at the server, wherever the streams are stored). Lastly, the user can be informed of the edited runtime of the edited audio stream/video stream, which differs from the recorded length of the original audio/video.

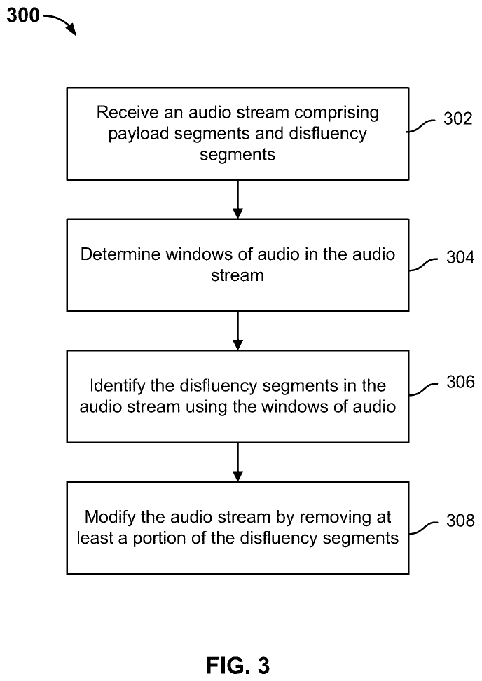

FIG. 3 is a flow diagram showing an embodiment of a process for removing disfluencies from an audio stream. In some embodiments, process 300 may be implemented, at least in part, at a device such as device 106 of system 100 of FIG. 1.

At 302, an audio stream comprising payload segments and disfluency segments is received. In some embodiments, the audio stream can be recorded (in real-time) at a device in conjunction with a video stream. In some embodiments, the audio stream and a time-aligned video stream have been previously recorded at the device or elsewhere. In various embodiments, the audio stream comprises a user's speech. The recorded user's speech in the audio stream includes disfluency segments, which are portions of the speech/audio stream where there is a disfluency event in the speech. As mentioned above, examples of a disfluency event include pauses, filler words (e.g., “uh” or “um”), stutters, an interjected sound or word, reparandums (e.g., correction of previously uttered speech), repetitions (e.g., of a syllable of a word), prolonged sounds, blocks or stops, and substitutions. Portions of the speech/audio stream that do not include disfluency segments are payload segments, which are portions of the user's speech in which disfluency events are not present.

At 304, windows of audio are determined in the audio stream. In some embodiments, windows (e.g., of a predetermined length of time) of audio (audio snippets within windows) of the audio stream are evaluated for the presence of disfluency segment within each window of audio. In some embodiments, the length of a window is selected to be longer than the length of expected disfluency events. For example, if the window is five seconds long, then five consecutive seconds of audio in the audio stream are evaluated at a time to detect whether a disfluency event is present within those five seconds. If a disfluency event is present, a corresponding disfluency segment is determined as a function of the start timestamp of the disfluency event and the end timestamp of the disfluency event. In some embodiments, machine learning is applied to each window of audio to detect for the presence of disfluency events within that window. The window (e.g., of a predetermined length of time) can be slid across the entire audio stream to evaluate for the presence of disfluency events within each window of audio. In some embodiments, the window can be shifted across time in either direction across the audio stream to evaluate windows of audio across the entire audio stream. Where the shift of the window is shorter than the length of the window, consecutive windows of audio will include overlapping audio from the audio stream.

In a first example, where the audio stream is still being recorded (e.g., has not finished recording), the window for determining an audio snippet to evaluate can be shifted at every predetermined interval across the audio stream as it is being recorded. In a second example, where the recording of the audio stream has completed, the window for determining an audio snippet to evaluate can also be shifted at every predetermined interval across the audio stream or windows spaced the predetermined interval apart can be applied in parallel to the audio stream to evaluate multiple windows of audio at once.

At 306, the disfluency segments are identified in the audio stream using the windows of audio.

At 308, the audio stream is modified by removing at least a portion of the disfluency segments. A disfluency segment is then evaluated, for example, in the context of other temporally neighboring disfluency segments, temporally neighboring payload segments, corresponding text transcription, and/or corresponding video frames in a time-aligned video stream, if available, to determine whether that disfluency segment should be removed from the audio stream. In some embodiments, in addition to removing a disfluency segment from the record audio stream, the video frames that correspond to the time-aligned video stream in between the start timestamp and end timestamp associated with that disfluency segment are also removed from the video stream.

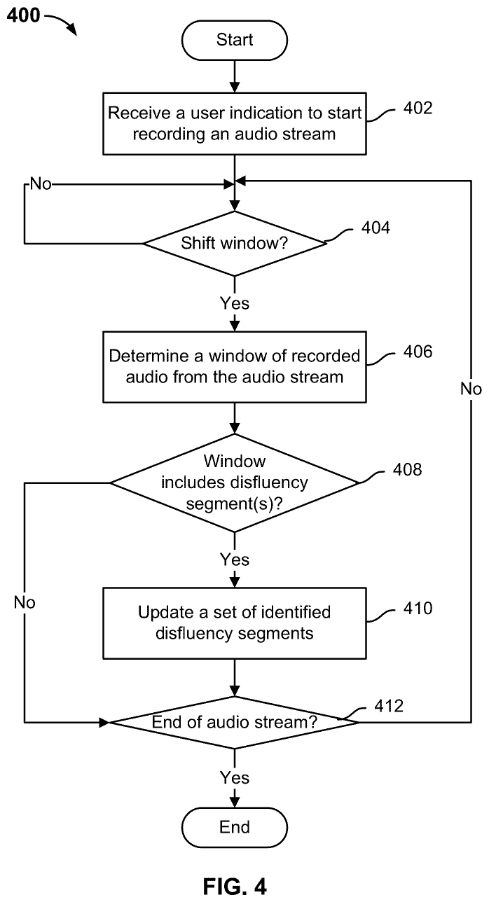

FIG. 4 is a flow diagram showing an example of a process for real-time identification of disfluency segments in windows of audio of an audio stream in accordance with some embodiments. In some embodiments, process 400 may be implemented, at least in part, at a device such as device 106 of system 100 of FIG. 1. In some embodiments, steps 304 and 306 of process 300 of FIG. 3 may be implemented, at least in part, using process 400.

Process 400 is an example process for identifying disfluency segments in an audio stream in real-time, as the audio stream is still being recorded. As will be described in process 400, below, as more audio is recorded in the audio stream, sliding windows of the most recently recorded audio are continuously evaluated for the presence of disfluency segments.

At 402, a user indication to start recording an audio stream is received. In some embodiments, the user indication to start recording an audio is received from an application for programmatic audio and/or video stream editing. In some embodiments, the recording of a time-aligned video stream is started at the same time as the recording of the audio stream.

At 404, whether a window of audio is to be shifted along the audio stream is determined. In the event that the window of audio is to be shifted along the audio stream, control is transferred to 406. Otherwise, in the event that the window of audio is not to be shifted along the audio stream, control is returned to 404. In some embodiments, at each predetermined interval (e.g., two seconds) since the start of the recording of the audio stream or in response to an indication that the audio recording has ended, a window of a predetermined length is shifted along the audio stream to obtain a new snippet of audio to evaluate for the presence of disfluency segments. In some embodiments, the window is initially aligned with the start of the audio stream and is then shifted the length of the predetermined interval through the audio stream at each predetermined interval to determine a new window of audio. In some embodiments, the window is continuously aligned with the (current) end of the audio stream at each predetermined interval or in response to an indication that the audio recording has ended. Put another way, the window is shifted to align with the (current) end of the audio stream at each predetermined interval or in response to an indication that the audio recording has ended.

At 406, a window of recorded audio is determined from the audio stream.

At 408, whether the window of recorded audio includes disfluency segment(s) is determined. In the event that the window of recorded audio includes disfluency segment(s), control is transferred to 410. Otherwise, in the event that the window of recorded audio does not include disfluency segment(s), control is transferred to 412.

Machine learning models (e.g., that have been modified to run efficiently on devices) are applied to each window of audio to identify the presence of one or more types of disfluency segments within that window of audio. For example, the window is five seconds long and machine learning is applied to a five-second snippet of audio to determine whether, in the context of the audio of that window, any portion of the five-second snippet includes a disfluency event. Where a disfluency event is identified in a window of audio, the corresponding disfluency segment, which includes at least the start timestamp and the end timestamp of that disfluency event, is stored.

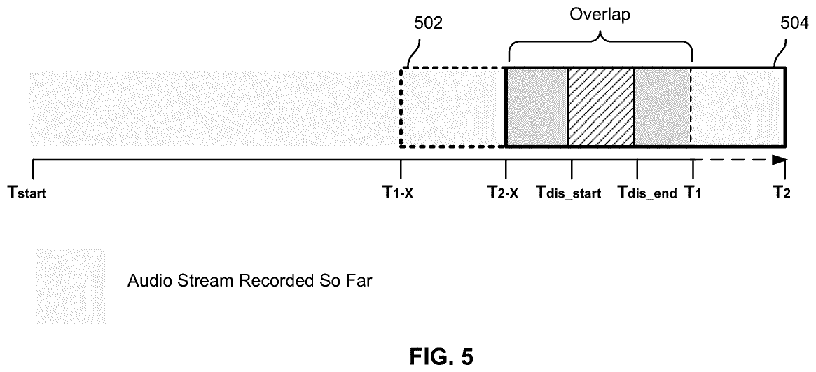

In the event that the predetermined interval of obtaining a new window of audio is shorter than the predetermined length of the window, then consecutive windows of audio may include overlapping audio content. For example, if the predetermined interval of obtaining a new window of audio is two seconds and the predetermined length of the window is five seconds, then consecutive/adjacent windows of audio include three seconds of overlapping audio. In some embodiments, because each window of audio is evaluated for the presence of disfluency events in the context of the audio within that window, the same audio content may be identified to include a disfluency event in one context/window that may otherwise not be detected in another context window. As such, allowing windows of audio to overlap in the detection of disfluency segments may improve the ability to catch disfluency events that may not be detected in one context but detectable in another context. FIG. 5, below, shows an example of overlapping windows of audio.

Returning to FIG. 4, at 410, a set of identified disfluency segments is updated. The set of identified disfluency segments includes for each disfluency segment that has been identified in the audio stream, a start timestamp and an end timestamp in the audio stream. As will be described further below, an identified disfluency segment that is stored for an audio stream can be determined to be removed from the audio stream.

At 412, whether an end of the completed audio stream has been evaluated for disfluency segments is determined. In the event that the end of the completed audio stream has been evaluated for disfluency segments, process 400 ends. Otherwise, in the event that the end of the completed audio stream has not been evaluated for disfluency segments, control is turned to 404. Whether the sliding window has been applied to all portions of the audio stream through the end of the recorded stream is determined. If the audio stream is still being recorded or if the window has not yet been applied to the end of the recorded audio stream after the recording of the stream has been completed, then the window is shifted at step 404 to get a new window of audio until the window has been applied through the entire audio stream.

FIG. 5 is a diagram showing two adjacent windows of audio that have been applied to an audio stream that is still being recorded. FIG. 5 shows that this audio stream started recording at time Tₛₜₐᵣₜ and has been recorded to time T₂ so far. As the audio stream has been recording, a window of length X has been periodically shifted to align with the current end of the in-progress audio stream and machine learning has been applied to each window of audio to detect for disfluency segments, if any, within that window. As shown in FIG. 5, window 504 of audio currently spans time T_{2-X} through time T₂ while window 502 previously spanned T_{1-X} through time T₁. Put another way, machine learning was applied to window 502 spanning T_{1-X} through time T₁ to identify any disfluency segments within that window and machine learning was then applied to window 504 spanning T_{2-X} through time T₂ to identify any disfluency segments within that window. In the example of FIG. 5, because the predetermined interval that the X-length window shifts through the audio stream is shorter than X, adjacent windows 502 and 504 include overlapping audio (the overlapping audio that spans time T_{2-X} through time T₁). As such, the overlapping audio spanning time T_{2-X} through time T₁ was evaluated within the context of window 502 and then evaluated again within the context of window 504 to determine for the presence of disfluency segments. Because windows 502 and 504 include differing audio as well as overlapping audio, the audio snippets in each window provide a different context in which disfluency events may be determined. In the example of FIG. 5, a disfluency segment spanning time T_{dis_start} through T_{dis_end}, which is included in the overlapping audio content between windows 502 and 504, was identified when machine learning was applied to window 504. In this particular example, the disfluency segment spanning time T_{dis_start} through T_{dis_end} was not detected in the context of window 502 but was detected within the context of window 504 (e.g., because the audio context of window 504 was different than the audio context of window 502). As shown in the example of FIG. 5, by applying sliding and overlapping windows through an audio stream, the audio of the stream is considered in more than one context, which provides a more thorough detection of disfluency segments.

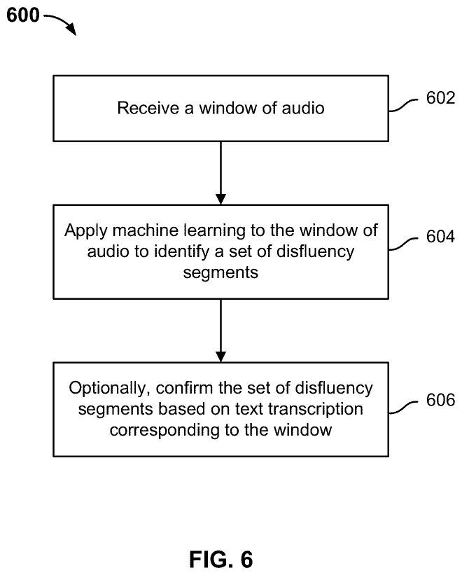

FIG. 6 is a flow diagram showing an example of a process for confirming identification of disfluency segments in windows of audio against text transcription in accordance with some embodiments. In some embodiments, process 600 may be implemented, at least in part, at a device such as device 106 of system 100 of FIG. 1. In some embodiments, steps 406 and 408 of process 400 of FIG. 4 may be implemented, at least in part, using process 600.

Process 600 is an example process for identifying the presence of each disfluency event that is determined from a window of audio and verifying whether that disfluency event is semantically meaningful based on the text transcription corresponding to that timeframe of that window.

At 602, a window of audio is received. A window of audio (an audio snippet that is of the predetermined length of a window) from an audio stream (that has concluded recording and/or whose recording is still in progress) is obtained.

At 604, machine learning is applied to the window of audio to identify a set of disfluency segments. Machine learning that has been trained to recognize the presence of disfluency events within audio is applied to the window of audio to determine segments within the window that include any disfluency events.

At 606, optionally, the set of disfluency segments is confirmed based on text transcription corresponding to the window. In some embodiments, each disfluency event that is detected by machine learning that was applied to the window of audio is checked against the text transcription corresponding to the timeframe associated with that window of audio to determine whether that detected disfluency segment is semantically meaningful or not in the context of the text transcription. If the text transcription confirms that the disfluency segment includes a disfluency event that is not semantically meaningful, then the corresponding disfluency segment will be included in a candidate removal segment that will be potentially removed from the audio stream, as will be described further below. Otherwise, if the text transcription supports that the disfluency segment includes semantically meaningful speech (e.g., a semantically meaningful filler word), then the corresponding disfluency segment is removed from the set of disfluency segments that is stored for the audio stream and also retained/preserved in the audio stream.

In a specific example, within the context of the text transcription of an audio stream, the presence of the word “um” is determined (e.g., using machine learning) to be always intentional, and so should be retained. As such, each disfluency segment that was detected in the audio stream that includes the utterance of “um” is determined to be intentional and therefore not included in the set of disfluency segments associated with the audio stream and is also retained/preserved in the audio stream.

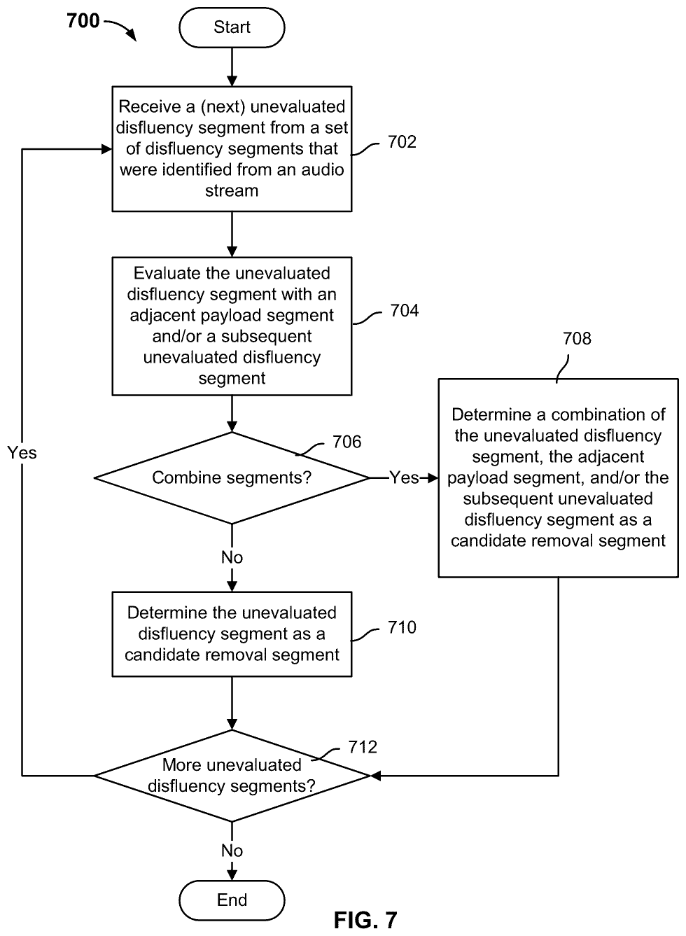

FIG. 7 is a flow diagram showing an example of a process for determining candidate removal segments based on identified disfluency segments in accordance with some embodiments. In some embodiments, process 700 may be implemented, at least in part, at a device such as device 106 of system 100 of FIG. 1.

Process 700 is an example process for determining whether to combine a single disfluency segment with another disfluency segment and/or a payload segment that is temporally close to that disfluency segment within the audio stream into a combined segment that is a candidate for removal from the audio stream (and also, a video stream, if available).

At 702, a (next) unevaluated disfluency segment is received from a set of disfluency segments that were identified from an audio stream. The set of disfluency segments were identified from an audio stream using a process such as process 400 of FIG. 4, above.

At 704, the unevaluated disfluency segment is evaluated with an adjacent payload segment and/or a subsequent unevaluated disfluency segment. In some embodiments, the unevaluated disfluency segment is considered along with a payload segment that is temporally close to the unevaluated disfluency segment in the audio stream to determine whether the removal of both segments would result in a fluent gap in the recorded user's speech. In some embodiments, the unevaluated disfluency segment is considered along with the adjacent payload segment and/or with a temporally close, subsequent unevaluated disfluency segment that was determined from the same audio stream to determine whether the removal of all three segments would result in a fluent gap in the recorded user's speech. For example, a fluent gap has two characteristics. Firstly, following the removal of one or more adjacent disfluent segments, the resulting audio segment associated with the fluent gap is both semantically coherent and does not break any grammatical rules. Secondly, a fluent gap has a natural duration of silence that elapses between each spoken word. The natural duration of silence can be normalized to each speaker, but has a general range defined by research. If the sentence makes sense and the amount of silence makes sense, then, in some embodiments, the removal of the segments would result in a fluent gap.

At 706, whether at least two segments should be combined is determined. In the event that at least two segments should be combined, control is transferred to 708. Otherwise, in the event that at least two segments should not be combined, control is transferred to 710. The result of combining the disfluency segment with at least one other segment and then removing the combined segments can be checked based on the text transcription corresponding to that portion of the audio stream before and after the hypothetical removal. If the hypothetical removal of the combination of the segments from the audio stream results in a fluent gap (or meets other criteria for combining) as reflected in the version of the text transcription with the removed combination of segments, then the combination of the segments is identified as a candidate removal segment. For example, a disfluency event could be followed by a (e.g., short) payload segment, which is in turn followed by another disfluency event. If it is determined that the hypothetical removal of the combination of the segments from the audio stream results in a fluent gap (or meets other criteria for combining), then the segments should be combined into one candidate removal segment.

At 708, a combination of the unevaluated disfluency segment, the adjacent payload segment, and/or the subsequent unevaluated disfluency segment is determined as a candidate removal segment. A candidate removal segment that comprises more than one temporally neighbor segment would include the start timestamp of the earliest appearing segment and the end timestamp of the latest appearing segment in the combination of segments.

At 710, the unevaluated disfluency segment is determined as a candidate removal segment. However, if it is determined that the hypothetical removal of the combination of the segments from the audio stream does not result in a fluent gap (or meets other criteria for combining), then the unevaluated disfluency segment is individually determined as a candidate removal segment. A candidate removal segment that comprises an individual disfluency segment would include the start timestamp of the disfluency segment and the end timestamp of that disfluency segment.

At 712, whether there is at least one more unevaluated disfluency segment is determined. In the event it is determined that there is at least one more unevaluated disfluency segment, control is returned to 702. Otherwise, in the event that there are no more unevaluated disfluency segments, process 700 ends.

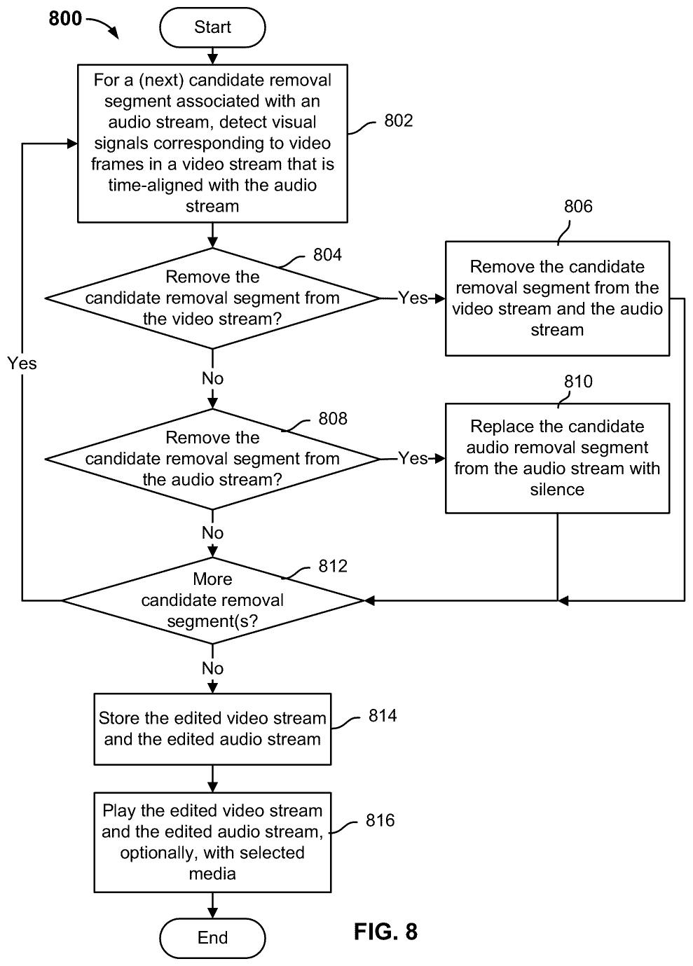

In some embodiments, all candidate removal segments that are determined (e.g., using a process such as process 700) are removed from the audio stream. In some other embodiments and where a time-aligned video stream corresponding to the audio stream is available, the candidate removal segments are selectively removed from each of the video stream and the audio stream in a process such as process 800, as described in FIG. 8, below.

FIG. 8 is a flow diagram showing an example of a process for selectively removing candidate removal segments from an audio stream and a time-aligned video stream in accordance with some embodiments. In some embodiments, process 800 may be implemented, at least in part, at a device such as device 106 of system 100 of FIG. 1. In some embodiments, step 308 of process 300 of FIG. 3 may be implemented using process 800.

Process 800 is an example process for determining whether to remove the video frames corresponding to a candidate removal segment from a video stream based on the content in the video frames corresponding to the candidate removal segment. Process 800 also describes that whether a candidate removal segment is removed from an audio stream is determined based, at least in part, on the content in the video frames corresponding to the candidate removal segment.

At 802, for a (next) candidate removal segment associated with an audio stream, visual signals are detected corresponding to video frames in a video stream that is time-aligned with the audio stream. The candidate removal segments were determined based on the disfluency segments (e.g., using a process such as process 700 of FIG. 7) that were identified from an audio stream (e.g., using a process such as process 400 of FIG. 4). A video stream was recorded with the audio stream and as a result, the video stream is time-aligned with the audio stream. In some embodiments, machine learning models (e.g., that were trained at a remote server to recognize visual signals in images and then simplified to run efficiently at a device) are applied to the video frames that correspond to the timeframe that spans the start timestamp through the end timestamp of the current candidate removal segment. For example, the machine learning models that are applied to the video frames are configured to recognize visual signals such as the user's expressions, text that is presented in the video frame, a shared screen/presentation (e.g., a presented document or slide deck), and/or the user's gestures that appear within the video frames.

At 804, whether the candidate removal segment is to be removed from the video stream is determined. In the event that the candidate removal segment is to be removed from the video stream, control is transferred to 806. Otherwise, in the event that the candidate removal segment is not to be removed from the video stream, control is transferred to 808. In the event that the visual signals that are recognized in the video frames that correspond to the timeframe that spans the start timestamp through the end timestamp of the current candidate removal segment meet a set of video preservation criteria, then those video frames are determined to be preserved/kept in the video stream (i.e., not removed from the video stream). Otherwise, in the event that the visual signals that are recognized in the video frames that correspond to the timeframe that spans the start timestamp through the end timestamp of the current candidate removal segment do not meet the set of video preservation criteria, then those video frames are determined to be removed from the video stream.

A first example of a video preservation criterion is that the visual signals indicate the user's intentionality to keep those video frames in the edited video stream, despite any corresponding disfluency events (e.g., silences, repetitive speech) that may be concurrently present in the corresponding timeframe of the audio stream. Specific examples of a user's intentionality include the presentation of a visual aid or the presentation of a document in the video frames. A second example of a video preservation criterion is that similar visual signals are not included in other video frames (e.g., that have been reviewed so far) of the video stream. A visual signal or a similar version that is not included in any other video frame in the audio stream may weigh in favor of preserving the video frame(s) from which it was detected in the video stream.

At 806, the candidate removal segment is removed from the video stream and the audio stream. If the video frames that correspond to the timeframe that spans the start timestamp through the end timestamp of the current candidate removal segment are determined to be removed from the video stream, then the corresponding audio segment that correspond to the timeframe that spans the start timestamp through the end timestamp of the current candidate removal segment is also removed from the audio stream. For example, if the candidate removal segments spanned start timestamp T₁ₛₜₐᵣₜ through end timestamp T_{1end}, then the video frames associated with the timeframe spanning T₁ₛₜₐᵣₜ through end timestamp T_{1end} will be removed (i.e., cut out) from the video stream and the audio segment spanning T₁ₛₜₐᵣₜ through end timestamp T_{lend} will be removed (i.e., cut out) from the audio stream.

At 808, whether the candidate removal segment is to be removed from the audio stream is determined. In the event that the candidate removal segment is to be removed from the audio stream, control is transferred to 810. Otherwise, in the event that the candidate removal segment is not to be removed from the audio stream, control is transferred to 812. In some instances, even though the video frames that correspond to the timeframe that spans the start timestamp through the end timestamp of the current candidate removal segment are not determined to be removed from the video stream, the corresponding audio segment that corresponds to the timeframe that spans the start timestamp through the end timestamp of the current candidate removal segment can still be removed from the audio stream. For example, if the audio segment that corresponds to the timeframe that spans the start timestamp through the end timestamp of the current candidate removal segment meets audio removal criteria, then the audio segment is removed from the audio stream.

A first example of an audio removal criterion is that the removal of the audio segment corresponding to the candidate removal segment would result in a smooth audio transition corresponding to the remaining audio that was temporally close to the removed audio. A second example of an audio removal criterion is that the removal of the audio segment corresponding to the candidate removal segment would result in a fluent gap in the remaining audio (e.g., as determined based on a hypothetical edit in the corresponding portion of the text transcription of the audio stream, as mentioned above). A third example of an audio removal criterion is that the removal of the audio segment corresponding to the candidate removal segment would match a historical speech pattern associated with the user. For example, previous audio streams that have been recorded by the user can be analyzed to determine historical speech patterns associated with the user and then the audio stream with the removed audio segment can be compared to the historical speech pattern to detect for a match.

Where the video frames corresponding to the timeframe of a candidate removal segment are determined to remain/be kept in the video stream and the corresponding audio segment is also determined to remain/be kept in the audio stream, then neither the video stream nor the audio stream need to be modified for that candidate removal segment.

At 810, the candidate audio removal segment is removed from the audio stream and replaced with silence. Where the video frames corresponding to the timeframe of a candidate removal segment are determined to remain/be kept in the video stream but that the corresponding audio segment is to be removed, the audio segment can still be removed (i.e., cut out) from the audio stream but replaced with silence. For example, the silence is the same length as the removed audio segment. The result of replacing the audio segment corresponding to the candidate removal segment with silence but preserving the video frames corresponding to that candidate removal segment in the video stream is that when the edited audio stream and the edited video stream are later presented/played, during the timeframe of the candidate removal segment, the video stream will play but there will be no audio of the user's (e.g., disfluent) speech. However, as will be described below, in some embodiments, during the presentation/playing of an edited audio stream and a time-aligned edited video stream, the presentation of a selected piece of media (e.g., a selected song) is overlaid the presentation of the edited video stream and audio stream, which will provide a sense of continuity in the overall playback experience despite the removal of any disfluent speech in the audio stream.

At 812, whether there is at least one more candidate removal segment is determined. In the event that there is at least one more candidate removal segment, control is returned to 802. Otherwise, in the event that there are no more candidate removal segments, control is transferred to 814. Steps 802 through 810 are repeated until all the candidate removal segments associated with an audio stream have been evaluated for removal from either one or both of the audio stream and its time-aligned video stream.

At 814, the edited video stream and the edited audio stream are stored. After being modified/edited by the removals of candidate removal segments, the video stream and the audio stream are respectively referred to as the “edited video stream” and the “edited audio stream.” In some embodiments, given that either a candidate removal segment is removed from both the video stream and the audio stream, or is removed only from the video stream and replaced with silence in the audio stream, the resulting edited video stream and edited audio stream should be of the same length. Also, because both the edited video stream and edited audio stream are shorter than their original, unedited counterparts, storing the edited video stream and edited audio stream in place of storing their original, unedited counterparts will save storage space.

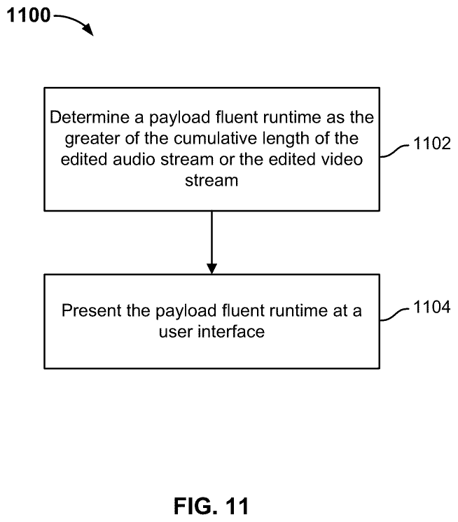

At 816, the edited video stream and the edited audio stream are played, and optionally, with selected media. The edited audio stream and its time-aligned edited video stream are presented simultaneously at the device. In some embodiments, the user can select to play a piece of media, such as a song, in the background of the presentation of the edited audio stream and its time-aligned edited video stream. Unlike the audio stream and the video stream, the selected piece of media is not edited and can play continuously in the background in a manner that overlays the presentation of the edited audio stream and its time-aligned edited video stream. In some embodiments, the runtime of a presentation of the edited audio stream and the edited video stream, which is sometimes referred to as the “payload fluent runtime,” can be determined and also presented. FIG. 11, below, describes an example of determining the payload fluent runtime.

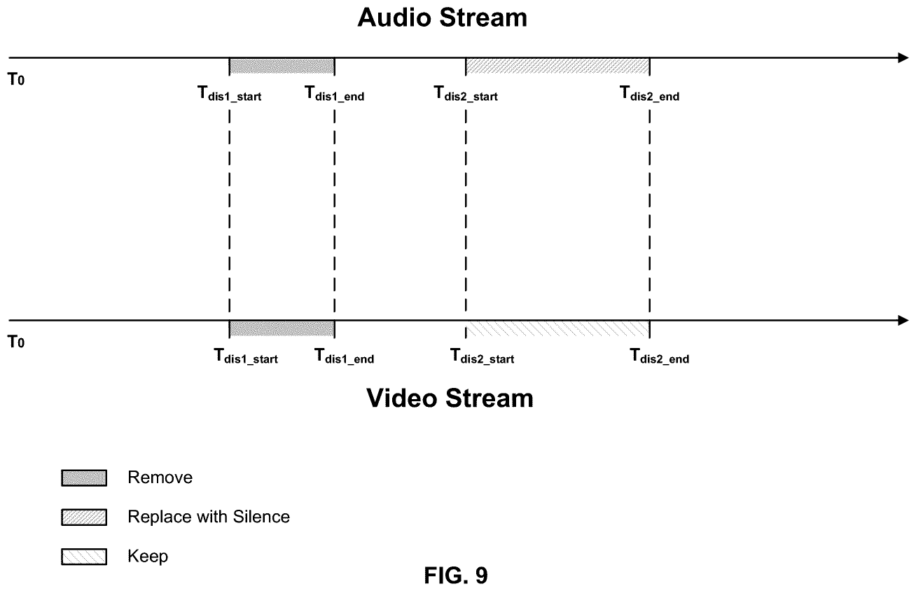

FIG. 9 is a diagram showing an example of selectively removing candidate removal segments from an audio stream and a time-aligned video stream. As shown in the example of FIG. 9, each of the audio stream and its time-aligned video stream begin at time To. A first candidate removal segment that spans start timestamp T_{dis1_start} through end timestamp T_{dis2_end} is evaluated for removal from the video stream using a process such as process 800 of FIG. 8. Based on the visual signals detected from the video frames corresponding to the first candidate removal segment spanning start timestamp T_{dis1_start} through end timestamp T_{dis1_end} not meeting the video preservation criteria, the video frames corresponding to the first candidate removal segment are determined to be removed from the video stream. Because the video frames corresponding to the first candidate removal segment are determined to be removed from the video stream, the audio segment corresponding to the same first candidate removal segment spanning start timestamp T_{dis1_start} through end timestamp T_{dis1_end} is determined to be removed from the video stream. Next, a second candidate removal segment that spans start timestamp T_{dis2_start} through end timestamp T_{dis2_end} is evaluated for removal from the video stream using a process such as process 800 of FIG. 8. Based on the visual signals detected from the video frames corresponding to the first candidate removal segment spanning start timestamp T_{dis2_start} through end timestamp T_{dis2_end} meeting the video preservation criteria, the video frames corresponding to the second candidate removal segment are determined to be kept/preserved in the video stream. However, despite the determination to keep the video frames corresponding to the second candidate removal segment in the video stream, the audio segment corresponding to the second candidate removal segment spanning start timestamp T_{dis2_start} through end timestamp T_{dis2_end} does meet the audio removal criteria and is therefore removed from the audio stream and replaced with an equivalent length of silence.

As such, during the playback of both the edited audio stream and the edited video stream, the presentation will not include the segment spanning start timestamp T_{dis1_start} through end timestamp T_{dis1_end} in either the audio stream or the video stream. However, during the playback of both the edited audio stream and the edited video stream, the presentation will include the video segment spanning start timestamp T_{dis2_start} through end timestamp T_{dis2_end} in the video stream but not the audio segment spanning that same segment (because that audio segment had been replaced by silence of the equivalent length). During the presentation of the edited audio stream and the edited video stream, a selected song can also be playing in the background.

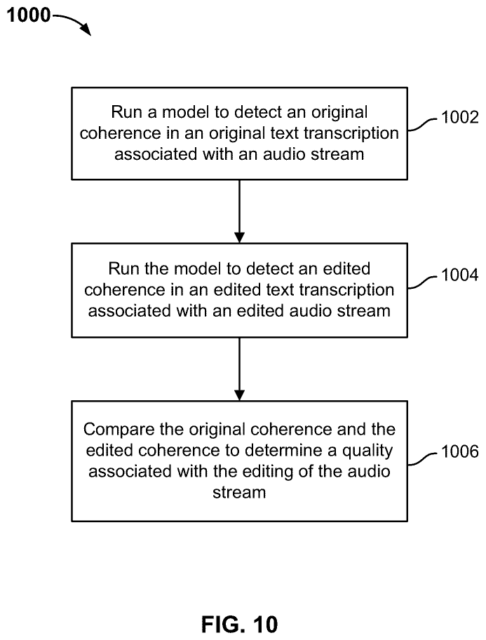

FIG. 10 is a flow diagram showing a process for verifying the quality of the editing of an audio stream in accordance with some embodiments. In some embodiments, process 1000 may be implemented, at least in part, at a device such as device 106 of system 100 of FIG. 1.

At 1002, a model is run to detect an original coherence in an original text transcription associated with an audio stream. A machine learning model that is configured to detect the coherence (the “original coherence”) in the text is applied to the text transcription of the original, unedited audio stream to determine a coherence associated with that text.

At 1004, the model is run to detect an edited coherence in an edited text transcription associated with an edited audio stream. The machine learning model that is configured to detect the coherence (the “edited coherence”) in text is applied to the text transcription of the edited audio stream to determine a coherence associated with that text. Because the edited audio stream has already been edited (e.g., using a process such as process 800 of FIG. 8) to remove disfluency segments, the corresponding text transcription also excludes the text portions that corresponded to those removed disfluency segments.

At 1006, the original coherence and the edited coherence are compared to determine a quality associated with the editing of the audio stream. One goal of editing the audio stream to remove disfluency segments from the audio stream is to provide more fluent narration by the speaker in the audio stream without degrading the coherence of the original speech. As such, it would be desirable for the edited coherence of the text transcription of the edited audio stream to closely match the original coherence of the text transcription of the original, unedited audio stream. In some embodiments, the ratio of the edited coherence to the original coherence is compared to a configurable threshold ratio. In the event that the ratio is less than the threshold ratio, then the machine learning models that had been applied to identify disfluency segments from the audio stream can be retrained to improve their identification of the segments that, at least some of which, will be ultimately removed from the edited audio stream.

FIG. 11 is a flow diagram showing a process for determining a payload fluent runtime associated with an edited audio stream in accordance with some embodiments. In some embodiments, process 1100 may be implemented, at least in part, at a device such as device 106 of system 100 of FIG. 1.

At 1102, a payload fluent runtime is determined as the greater of the cumulative length of the edited audio stream or the edited video stream. Given that the audio stream and its time-aligned video stream, if available, have been edited to remove disfluency segments, the runtime of the edited streams are (likely) shorter than their original counterparts. Also, given that, in some instances, segments can be kept in the video stream (if available) but removed from the audio stream (e.g., and replaced with silence) (e.g., as described in a process such as process 800 of FIG. 8), the edited video stream can be longer than the edited audio stream. As a result, the runtime of the presentation of the edited stream(s) that are stored is determined as the longer of the edited video stream and the edited audio stream. Because the edited audio/video streams are to include (mostly) fluent narration (after the disfluency segments have been removed), the runtime of the edited stream(s) is sometimes referred to as the “payload fluent runtime.”

At 1104, the payload fluent runtime is presented at a user interface. The payload fluent runtime, which is usually shorter than the actual runtime of the recorded audio stream (and its corresponding time-aligned video stream), is presented at a user interface at the device along with the original runtime of the recorded audio stream to inform the user of the runtime of the edited version of the recorded audio and/or video.

By programmatically removing disfluencies in a user's recorded speech from an audio stream (and from a time-aligned video stream), the resulting audio (and video) provides more fluent narration that is more engaging for viewers. Furthermore, because the identification of disfluencies of the recorded speech can be made in real-time, the edited speech can be made available for the user quickly and without requiring any video editing skills on the part of the user. The user can therefore enjoy recording audio and/or video presentations with fluent narration using their personal devices anytime and anywhere, without needing the use of a professional video production team or spending time manually editing their audio/videos.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
receive an audio stream comprising payload segments and disfluency segments;
determine windows of audio in the audio stream;
identify the disfluency segments in the audio stream using the windows of audio; and
modify the audio stream by removing at least a portion of the disfluency segments; and
a memory coupled to the processor and configured to provide the processor with instructions.

2. The system of claim 1, wherein the disfluency segments are associated with disfluency events, wherein the disfluency events comprise one or more of the following: a pause, a filler word, an interjected sound or word, a stutter, a repetition of a syllable or word, a reparandum, a is prolonged sound, a block or a stop, and a substitution.

3. The system of claim 1, wherein to determine the windows of audio in the audio stream comprises to slide a window along the audio stream to obtain the windows of audio as the audio stream is being recorded in real-time.

4. The system of claim 1, wherein adjacent windows in the windows of audio include overlapping audio.

5. The system of claim 1, wherein to identify the disfluency segments in the audio stream using the windows of audio comprises to apply machine learning to the windows of audio to determine locations of disfluency events within the windows of audio.

6. The system of claim 5, wherein the processor is further configured to confirm the disfluency events within the windows of audio based at least in part on a text transcription corresponding to the audio stream.

7. The system of claim 1, wherein the processor is further configured to determine a candidate removal segment as comprising either a disfluency segment or a combination of the disfluency segment with at least one of an adjacent payload segment and a subsequent disfluency segment.

8. The system of claim 7, wherein to modify the audio stream by removing the at least a portion of the disfluency segments comprises to remove an audio segment from the audio stream corresponding to the candidate removal segment.

9. The system of claim 7, wherein the audio stream is associated with a video stream, wherein the video stream is time-aligned to the audio stream, and wherein to modify the audio stream by removing the at least a portion of the disfluency segments comprises to:
detect visual signals in a set of video frames from the video stream, and wherein the set of video frames corresponds to the candidate removal segment;
in response to a determination that the visual signals meets a set of video preservation criteria:
determine to preserve the set of video frames in the video stream;
determine whether an audio segment that corresponds to the candidate removal segment meet a set of audio removal criteria; and
in response to a determination that the audio segment that corresponds to the candidate removal segment meet the set of audio removal criteria, replace the audio segment in the audio stream with silence.

10. The system of claim 7, wherein the audio stream is associated with a video stream, wherein the video stream is time-aligned to the audio stream, and wherein to modify the audio stream by removing the at least a portion of the disfluency segments comprises to:
detect visual signals in a set of video frames from the video stream, and wherein the set of video frames corresponds to the candidate removal segment;
in response to a determination that the visual signals do not meet a set of video preservation criteria:
remove the set of video frames from the video stream; and
remove an audio segment that corresponds to the candidate removal segment from the audio stream.

11. The system of claim 1, wherein the processor is further configured to store the modified audio stream, and wherein the modified audio stream is shorter than the audio stream prior to modification.

12. The system of claim 1, wherein the processor is further configured to present the modified audio stream and overlay a selected media over the presentation of the modified audio stream.

13. The system of claim 1, wherein the processor is further configured to:
determine an original coherence in an original text transcription associated with the audio stream prior to modification;
determine an edited coherence in an edited text transcription associated with the modified audio stream; and
compare the edited coherence to the original coherence.

14. The system of claim 1, wherein the audio stream was previously recorded.

15. A method, comprising:
receiving an audio stream comprising payload segments and disfluency segments;
determining windows of audio in the audio stream;
identifying the disfluency segments in the audio stream using the windows of audio; and
modifying the audio stream by removing at least a portion of the disfluency segments.

16. The method of claim 15, wherein adjacent windows in the windows of audio include overlapping audio.

17. The method of claim 15, wherein identifying the disfluency segments in the audio stream using the windows of audio comprises applying machine learning to the windows of audio to determine locations of disfluency events within the windows of audio.

18. The method of claim 15, further comprising storing the modified audio stream, and wherein the modified audio stream is shorter than the audio stream prior to modification.

19. The method of claim 15, further comprising presenting the modified audio stream and overlaying a selected media over the presentation of the modified audio stream.

20. A computer program product, the computer program product being embodied in a non-transitory computer readable storage medium and comprising computer instructions for:
receiving an audio stream comprising payload segments and disfluency segments;
determining windows of audio in the audio stream;
identifying the disfluency segments in the audio stream using the windows of audio; and
modifying the audio stream by removing at least a portion of the disfluency segments.
